(19) United States
(12) Patent Application Publication
(10) Pub. No.: US 2007/0263382 A1
(43) Pub. Date: Nov. 15, 2007

(54) FLASHLIGHT WITH LOCK BAR

(75) Inventors: Kevin J. Tarter, Wichita, KS (US); Jake L. Hillard, Wichita, KS (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: THE COLEMAN COMPANY, INC., Wichita, KS (US)

(21) Appl. No.: 11/748,019

(22) Filed: May 14, 2007

Related U.S. Application Data
(60) Provisional application No. 60/747,253, filed on May 15, 2006.

(51) Int. Cl. F21L 4/00

(52) U.S. Cl. 362/208; 362/116; 362/202; 362/253

(57) ABSTRACT

A flashlight having a lock bar. The lock bar is positioned at an end cap of the flashlight, and is U-shaped with two ends. Both ends are captured within the flashlight in a first, closed position, and a second, shorter end is released in a second, open position. While in the open position, the lock bar may be looped around a structure, such as a carabineer, a hook, a keychain, or a belt loop. The lock bar may then be returned to the closed position and locked into place so that the lock bar stays latched to the structure.

### REFERENCE TO RELATED APPLICATION

This patent application claims the benefit of U.S. Provisional Patent Application No. 60/747,253, filed May 15, 2006, and incorporated herein in its entirety.

### TECHNICAL FIELD OF THE INVENTION

The present invention is directed to lights, and more particularly to flashlights.

### BACKGROUND OF THE INVENTION

In general, a flashlight is a portable electric light, such as a luminaire configured to be held by a user. Flashlights are useful for a variety of different applications, including use for light in the outdoors, backup lighting in a power outage, or as a source of light to find an object in a dark location.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a flashlight is provided having a lock bar. In an embodiment, the lock bar is positioned on an end cap of the flashlight, and the lock bar is U-shaped with first and second ends. Both ends are captured within the flashlight when the U-shaped lock bar is pressed into the flashlight at a first position, and the second, shorter end is released when the U-shaped lock bar is pulled out of the flashlight to a second position. While in the second position, the opened lock bar may be looped around a structure, such as a carabineer, a hook, a keychain, or a belt loop. The lock bar may then be returned to the first position and locked into place so that the lock bar is latched around the structure.

In an embodiment, the lock bar may be released by a rotating collar. To release the lock bar, the rotating collar may include, for example, a latch plate that extends into a notch in the lock bar. This rotating collar may be spring biased into a locked position. In addition, the latch plate may be chamfered so that insertion of the lock bar causes simultaneous movement of the latch plate out of the way.

Other features of the invention will become apparent from the following detailed description when taken in conjunction with the drawings, in which:

### BRIEF DESCRIPTION OF THE DRAWINGS

FIG. 1 is a top view of a flashlight in accordance with an embodiment;

FIG. 2 is side perspective view of an end cap for the flashlight of FIG. 1, with a lock bar in a closed position;

FIGS. 3-5 are side perspective views of the end cap of FIG. 2, showing progressive steps of release and rotation of the lock bar;

FIG. 6 is an exploded side perspective view of the end cap of FIG. 2, with the rotating collar removed for detail;

FIG. 7 is a bottom, exploded side perspective view of the end cap of FIG. 2, with the rotating collar removed for detail;

FIG. 8 is a side perspective view of the end cap of FIG. 2, with a cap removed for detail;

FIG. 9 is a side perspective view, similar to FIG. 8, with the rotating collar rotated so that a latch plate on the rotating collar locks the lock bar into place;

FIG. 10 is a detail view showing approach of the lock bar to the latch plate for the rotating collar; and

FIG. 11 is a detail view, similar to FIG. 10, with the latch plate in place in the notch of the lock bar.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order to not obscure the embodiment being described.

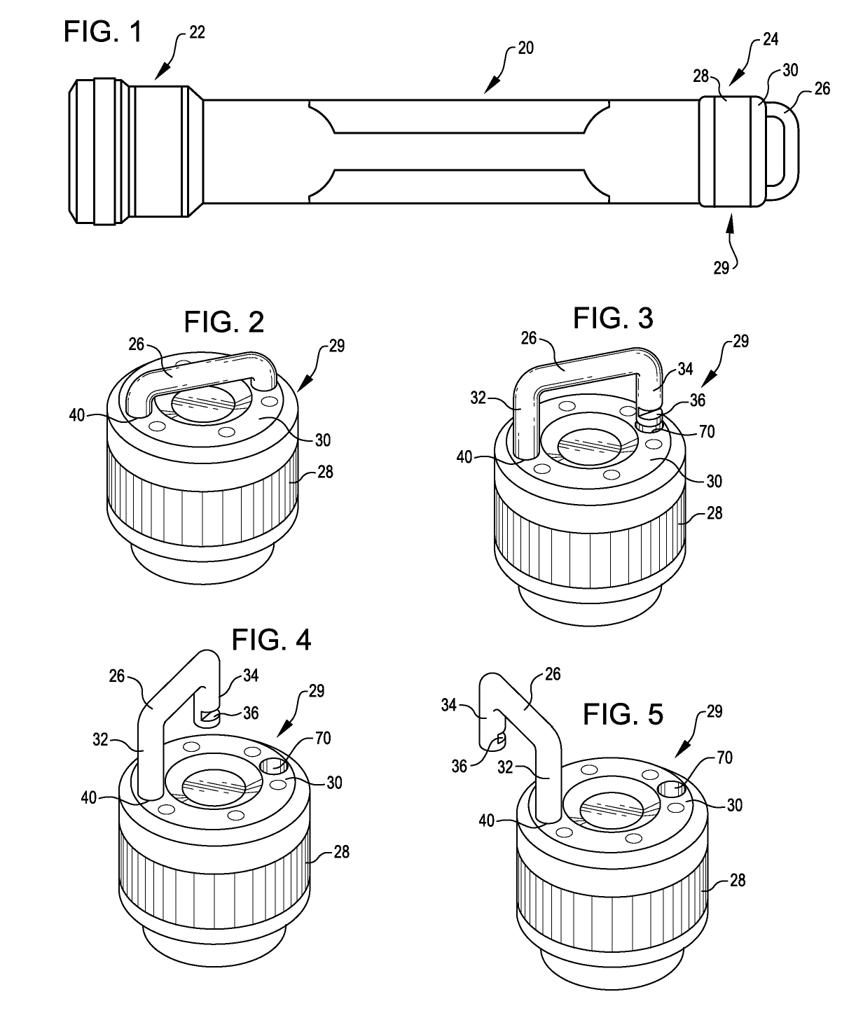

Referring now to the drawings, in which like reference numerals represent like parts throughout the several views, FIG. 1 shows a flashlight 20 incorporating an embodiment of the invention. The flashlight includes a head end 22 and a tail end 24. As is conventional, the flashlight includes a body (i.e., the exterior of the flashlight), a power source, such as batteries, in the body, and at least one lamp connected to the power source. In the embodiment shown in the drawings, the lamp may be positioned in the head end of the flashlight.

In accordance with an embodiment, the flashlight 20 includes a lock bar 26 that is releasable by rotation of a rotating collar 28. As can be seen in FIGS. 2-5, releasing the lock bar 26 frees one end of the lock bar so that the lock bar may be hooked around a structure, such as a ring, carabineer, a loop, a hook, a keychain, or a belt loop. The lock bar 26 may then be moved back to the closed position in FIG. 2 so that the lock bar and the flashlight are latched to the structure.

In an embodiment, the lock bar 26 and the rotating collar 28 are located on an end cap 29 (FIG. 2) for the flashlight 20. The end cap 29 is attached to the tail end 24 of the flashlight. Alternatively, the lock bar 26 may be positioned so that it extends out of a side of the flashlight 20, or a front portion of the flashlight. However, for ease of description, embodiments described herein include the lock bar 26 and the rotating collar 28 positioned at the end cap 29 of the flashlight.

A stationary cap 30 is positioned at the distal end of the end cap 29. On the underside of this stationary cap is a threaded post 31 (FIG. 7). The threaded post 31 is designed to be rotated onto a threaded stud (not shown) on the tail end 24 of the flashlight 20. In alternate embodiments, the end cap 29 may be attached in other ways, such as by gluing, friction fit, fasteners, or another suitable mechanism or method.

The lock bar 26 shown in the drawings is U-shaped and includes a longer end 32 which extends through the cap 30 in both the closed position shown in FIG. 2 and in the open position shown in FIGS. 4 and 5. The lock bar 26 also includes a shorter, latching end 34. The latching end 34 is attached to the end cap 29 when the lock bar 26 is in the closed position shown in FIG. 2, but is free from the end cap 29 in the open position shown in FIGS. 4 and 5. In an embodiment, when the latching end 34 is in this open position, the lock bar 26 is free to rotate about the longer end 32.

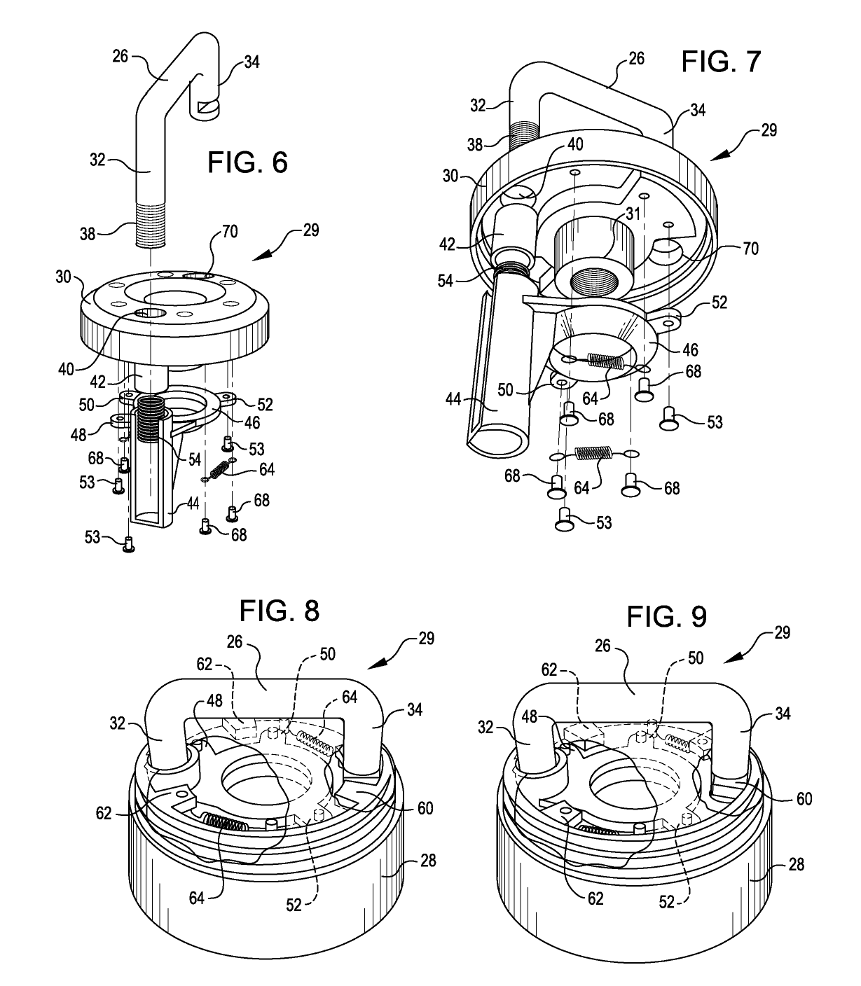

The latching end 34 includes a notch 36 at its distal end. The longer end 32 includes male threads 38 (FIG. 6) at its distal end.

To attach the lock bar 26 to the end cap 29, the threaded end 38 of the longer end 32 of the lock bar 26 is extended through an opening 40 (FIG. 7) on the cap 30. A stop 42 is threaded onto the threads 38. This stop 42 prevents the lock bar 26 from being removed from the end cap 29.

The stop 42 fits into a sleeve 44 mounted below the cap 30. The sleeve 44 may be made of a low friction material to allow the stop 42 to slide up and down its length. The sleeve 44 is attached to a ring 46 having dog ears 48, 50, 52. As can be seen in FIG. 7, fasteners 53, such as screws, may be used to attach the dog ears 48, 50, 52 to the underside of the cap 30.

As can be seen in FIGS. 8-11, the rotating collar 28 includes a latch plate 60 extending inward from a top edge of the rotating collar. In addition, in accordance with an embodiment, the rotating collar 28 includes two inwardly aligned protrusions 62. In an embodiment, as can be seen in FIGS. 7 and 8, opposite ends of springs 64, 66 are attached to an underside of the cap 30 and the inwardly aligned protrusions 62. These springs 64, 66 bias the rotating collar 28 in a counterclockwise position, or to the right as shown in FIG. 8. The springs 64, 66 are held in position by fasteners 68 (FIG. 7).

In use, when the lock bar 26 is in the closed or locked position shown in FIG. 2, the latching end 34 of the lock bar 26 extends into an opening 70 (FIG. 4) in the cap 30, and the latch plate 60 is seated in the notch 36 of the latching end 34 of the lock bar (see FIG. 11). At this position, the latch plate 60 prevents the lock bar 26 from being pulled out of the cap 30. The springs 64, 66 bias the latch plate 60 into this position, and prevent accidental disengagement of the lock bar 26. Although in the embodiment shown in the drawings the latch plate 60 engages the notch 36 of the latching end 34 of the lock bar 26, a similar latch plate may alternatively or additionally be used to engage a similar latch in the longer end 32. In addition, other locking structures may be used for holding the lock bar 26 in the first position. For example, although described herein as using a notch and a latch plate, the lock bar 26 may include any type of protrusion that is selectively engaged by a stop.

To release the lock bar 26, a user grasps the rotating collar (FIG. 8), and rotates the rotating collar clockwise, or to the left in FIG. 8. This rotation is against the bias of the springs 64, 66. During this movement, the latch plate 60 moves out of the notch 36 of the latching end 34 for the lock bar 26. Once the latch plate 60 is fully removed from the notch 36, the spring 54 beneath the longer end 32 of the lock bar 26 presses the lock bar upward. The latching end 34 of the lock bar 26 is thus released from the end cap 29. The stop 42 prevents the lock bar 26 from detaching from the end cap 29.

As can be seen in FIGS. 4 and 5, after the latching end 34 is released, the lock bar 26 may be rotated relative to the end cap 29 about a longitudinal axis of the longer end 32 of the lock bar. The lock bar 26 may then be hooked around an appropriate structure, such as a loop, a carabineer, or another suitable structure.

After the latching end 34 is released from the end cap 29, the user may release the rotating collar 28. The springs 64, 66 rotate the rotating collar back to the initial position, aligning the latch plate 60 in the opening 70 (FIG. 7) in the cap 30. This opening 70 is the hole into which the latching end 34 extends when the lock bar 26 is in the closed position shown in FIG. 2.

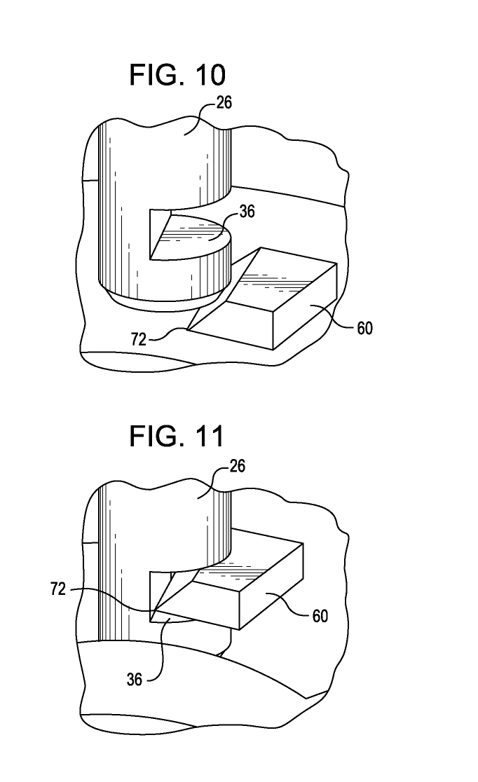

To close the lock bar 26, the lock bar 26 is rotated to align the latching end 34 with the opening 70, and the lock bar is pressed toward the end cap 29 against the bias of the spring 54. As can be seen in FIG. 10, the distal end of the latching end 34 engages the latch plate 60 upon entering the opening 70. To permit the latch plate to move out of the opening so that the latching end 34 may enter, in accordance with an embodiment, the latch plate 60 includes a chamfered leading edge 72. This chamfered leading edge 72 causes the latch plate 60 to move sideways as the tip of the latching end 34 presses into place. The tip of the latching end 34 engages the chamfered leading edge 72, and drives the latch plate 60 sideways, rotating the collar 28. The tip of the latching end 34 continues to press the latch plate 60 sideways until the latch plate 60 contacts the outside edge of the latching end 34 of the lock bar 26. Continued insertion of the lock bar 26 causes the notch 36 to align with the latch plate 60, and the latch plate pops into place in the notch. In an embodiment, an audible click may be provided so that the user is given audible feedback that the lock bar 26 has been locked into position. The springs 64, 66 drive the latch plate 60 into the notch 36 and prevent inadvertent removal after the latch plate is in place.

The flashlight 20 provides a unique function in that the lock bar 26 may be attached to a structure, such as a carabineer or a belt loop of an individual, and the flashlight is securely held in place. In addition, the rotating collar 28 provides a fast and easy way to release the lock bar 26, so that the flashlight may be released and held by a user.

Although the release mechanism described above is a rotating collar 28, an alternate release mechanism may be a sliding bar, a button, latch, or other suitable release structure. In addition, the lock bar 26 may be configured in a different way in accordance with a desired effect. In general, however, the lock bar includes a structure connected to the flashlight that in a first position provides a closed loop, a portion of which may be defined by the flashlight. In a second position, the structure provides an open loop so that the lock bar may be hooked onto something.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A flashlight, comprising:
a body; and
a lock bar connected to the body, the lock bar in a first position providing a closed loop and in a second position providing an open loop.

2. The flashlight of claim 1, further comprising a head end and a tail end, and wherein the lock bar is connected to the tail end of the flashlight.

3. The flashlight of claim 2, further comprising an end cap at the tail end, and wherein the lock bar is connected to the end cap.

4. The flashlight of claim 1, wherein the lock bar is releasably lockable in the first position.

5. The flashlight of claim 4, further comprising a rotating collar, and wherein the lock bar is releasable by rotation of the rotating collar.

6. The flashlight of claim 5, wherein the lock bar comprises a protrusion and the rotating collar comprises a stop that is releasably engagable with the protrusion to releasably lock the lock bar in the first position.

7. The flashlight of claim 5, further comprising an end cap, and wherein the lock bar and the rotating collar are positioned on the end cap.

8. The flashlight of claim 7, wherein the lock bar is U-shaped and comprises:
a longer end which extends through the end cap in both the first position and the second position; and
a shorter end which extends into the end cap in the first position but not in the second position.

9. The flashlight of claim 8, wherein, when the lock bar is in the second position, the lock bar is free to rotate about the longer end.

10. The flashlight of claim 8, wherein the lock bar comprises a protrusion and the rotating collar comprises a stop that is releasably engagable with the protrusion to releasably lock the lock bar in the first position.

11. The flashlight of claim 10, wherein the stop is mounted for rotation with the rotating collar.

12. The flashlight of claim 11, wherein the rotating collar is biased to engage the stop with the protrusion when the lock bar is in the first position.

13. The flashlight of claim 12, wherein the protrusion comprises a notch on the lock bar, and wherein the stop comprises a latch plate.

14. The flashlight of claim 13, wherein the latch plate comprises a chamfered leading edge.

15. The flashlight of claim 10, wherein at least one of the stop and the protrusion comprise a chamfered leading edge.

16. The flashlight of claim 1, wherein a portion of the closed loop comprises the body of the flashlight.

17. The flashlight of claim 1, further comprising a release mechanism for releasably locking the lock bar in the first position.

18. The flashlight of claim 17, wherein the release mechanism comprises a stop for selectively engaging a protrusion on the lock bar.

19. The flashlight of claim 18, wherein the stop is biased to engage the protrusion when the lock bar is in the first position.

20. The flashlight of claim 18, wherein the protrusion comprises a notch on the lock bar, and wherein the stop comprises a latch plate.

21. The flashlight of claim 20, wherein the latch plate comprises a chamfered leading edge.

22. The flashlight of claim 18, wherein at least one of the stop and the protrusion comprise a chamfered leading edge.

23. The flashlight of claim 1, wherein the lock bar is biased to the second position.

24. The flashlight of claim 1, wherein the lock bar is U-shaped and comprises:
a longer end which extends into the body in both the first position and the second position; and
a shorter end which extends into the body in the first position but not in the second position.

25. The flashlight of claim 24, wherein, when the lock bar is in the second position, the lock bar is free to rotate about the longer end.
